(19) United States
(12) Patent Application Publication
(10) Pub. No.: US 2011/0075179 A1
(43) Pub. Date: Mar. 31, 2011

(54) IMAGE PROCESSING APPARATUS THAT PERFORMS AUTHENTICATION, AUTHENTICATION METHOD THEREFOR, AND STORAGE MEDIUM

(75) Inventor: Keiko UTSUMI, Yokohama-shi (JP)

(73) Assignee: CANON KABUSHIKI KAISHA, Tokyo (JP)

(21) Appl. No.: 12/893,336

(22) Filed: Sep. 29, 2010

(30) Foreign Application Priority Data
Sep. 29, 2009 (JP) 2009-224770

(51) Int. Cl. G06F 3/12

(52) U.S. Cl. 358/1.13; 358/1.14

(57) ABSTRACT

An image processing apparatus that can perform authentication even in a case where a card reader for use in authentication fails when providing services for a user by performing authentication. When a failure of the card reader that inputs identification information is not detected, authentication is performed in a first authentication process using the identification information input by the card reader. When a failure of the card reader is detected, authentication is performed in a second authentication process using information of an image read by a scanner of the image processing apparatus. When authentication performed in the first authentication process or the second authentication process is successful, usage of the image processing apparatus is permitted.

### BACKGROUND OF THE INVENTION

1. Field of the Invention

The present invention relates to an image processing apparatus that performs authentication, an authentication method therefor, and a computer-readable storage medium storing a program.

2. Description of the Related Art

In recent years, as IC cards have become widespread, there have emerged a number of systems in which an apparatus connected to an authentication server via a line such as a network authenticates a user by reading various types of information from his/her IC card, and further restricts services, functions, and so on which can be provided for the authenticated user.

Such IC card authentication systems have avoidance measures incorporated therein so as to perform authentication even when hardware or system fails.

For example, Japanese Laid-Open Patent Publication (Kokai) No. 2007-026341 describes a “failure avoidance method for a card using system”. According to this method, alternative paths to be used when an authentication server and an IC card authentication device cannot be connected together for some reason are registered in advance, and when connection to the authentication server fails, connection to the authentication server is established using an alternative path registered in advance so as to provide services.

However, the above described prior art has a problem described hereafter. As described above, when a problem occurs in a connection path between the authentication server and a service providing apparatus, authentication can be performed by changing connection paths. However, a card reader portion of the service providing apparatus fails, authentication cannot be performed, and hence any services cannot be provided.

### SUMMARY OF THE INVENTION

The present invention provides an image processing apparatus that can perform authentication even in a case where a card reader portion for use in authentication fails when providing services for a user by performing authentication, an authentication method therefor, and a computer-readable storage medium storing a program.

Accordingly, in a first aspect of the present invention, there is provided an image processing apparatus that has a scanner that reads images, and performs printing processing on images read by the scanner, comprising an input unit configured to input identification information, a first authentication unit configured to perform authentication using the identification information input by the input unit, a failure detection unit configured to detect a failure of the input unit, a second authentication unit configured to perform authentication using information on an image read by the scanner, a usage permission unit configured to permit usage of the image processing apparatus when authentication performed by the first authentication unit or the second authentication unit is successful, and a switching unit configured to switch from authentication performed by the first authentication unit to authentication performed by the second authentication unit when the failure detection unit detects a failure of the input unit.

Accordingly, in a second aspect of the present invention, there is provided an authentication method for an image processing apparatus that performs printing processing on images read by a scanner, comprising a failure detection step of detecting a failure of an input unit that inputs identification information, a first authentication step of, when a failure of the input unit is not detected in the failure detection step, performing authentication using the identification information input by the input unit, a second authentication step of, when a failure of the input unit is detected in the failure detection step, performing authentication using information of an image read by the scanner, and a usage permission step of permitting usage of the image processing apparatus when authentication performed in the first authentication step or the second authentication step is successful.

Accordingly, in a third aspect of the present invention, there is provided a non-transitory computer-readable storage medium storing a program for causing a computer to execute an authentication method for an image processing apparatus that performs printing processing on images read by a scanner, the authentication method comprising, a failure detection step of detecting a failure of an input unit that inputs identification information, a first authentication step of, when a failure of the input unit is not detected in the failure detection step, performing authentication using the identification information input by the input unit, a second authentication step of, when a failure of the input unit is detected in the failure detection step, performing authentication using information of an image read by the scanner, and a usage permission step of permitting usage of the image processing apparatus when authentication performed in the first authentication step or the second authentication step is successful.

According to the present invention, when a failure of the input unit is detected, authentication is switched from authentication performed by the first authentication unit to authentication performed by the second authentication unit. As a result, authentication can be performed even in a case where the input unit (for example, a card reader) fails when services are provided for the user by performing authentication. Namely, by switching to authentication performed by the second authentication unit using the scanner of the image processing apparatus, services can be continuously provided for the user.

Further features of the present invention will become apparent from the following description of exemplary embodiments (with reference to the attached drawings).

### BRIEF DESCRIPTION OF THE DRAWINGS

FIG. 1 is a diagram schematically showing an overall arrangement of an image forming system according to an embodiment of the present invention.

FIG. 2 is a block diagram schematically showing an arrangement of a controller unit of an image forming apparatus (MFP).

FIG. 3 is a diagram useful in explaining a first authentication method.

FIG. 4 is a diagram showing data required to detect a failure of a card reader.

FIGS. 5A and 5B are diagrams showing notification screens for a user, which are displayed on a display device of the MFP.

FIG. 6 is a flowchart showing procedures of an authentication switching process.

FIG. 7 is a flowchart showing procedures of a first authentication process in step S3.

FIG. 8 is a diagram showing exemplary data stored in a user information DB.

FIGS. 9A and 9B are views showing tables providing a listing of information on an ID card and settings on a second authentication method, which are stored in a ROM in the controller unit of the MFP.

FIGS. 10A to 10C are diagrams showing types of ID cards to be used.

FIG. 11 is a diagram showing an exemplary log stored in a case where log obtainment is configured in the second authentication method.

FIG. 12 is a diagram showing an entry control system and a user authentication system.

FIG. 13 is a flowchart showing procedures of a second authentication process in step S5.

FIG. 14 is a flowchart showing procedures of a user ID obtaining process in step S24.

### DESCRIPTION OF THE EMBODIMENTS

A description will now be given of an embodiment of the present invention with reference to the drawings. The image processing apparatus according to the embodiment is applied to an image forming system.

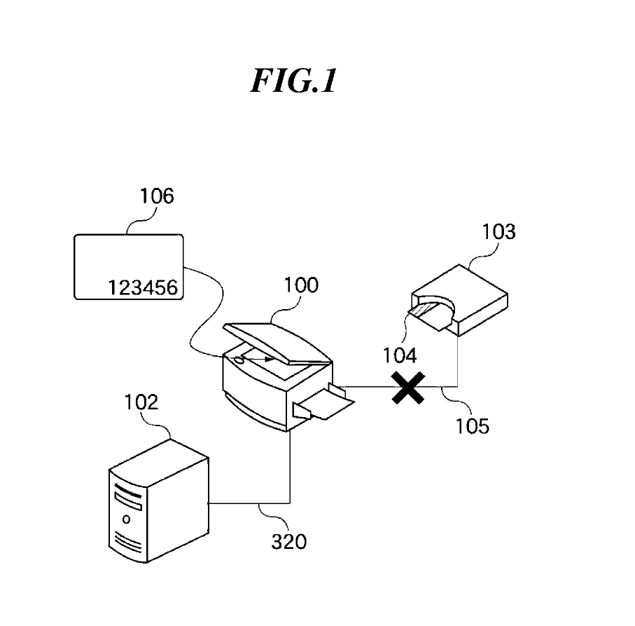

FIG. 1 is a diagram schematically showing an overall arrangement of the image forming system according to the embodiment. The image forming system is comprised mainly of an ID card 106 owned by a user, a multifunctional peripheral (MFP) 100 which is an image forming apparatus, a card reader 103, and an authentication server 102. The MFP 100 has a copy function, a facsimile function, a scanner function, and so on.

By inserting the ID card 106 into the card reader 103 and undergoing user authentication, the user can use the MFP 100.

When performing authentication in a normal mode, the MFP 100 reads data recorded in the ID card 106 using the card reader 103 connected to a USB cable 105 routed through a USB host, and sends the read data to the authentication server 102 with which the MFP 100 can communicate.

Then, upon receiving notification about successful authentication from the authentication server 102, the MFP 100 shifts to a usable mode. However, when the card reader 103 is unusable for some reason, the MFP 100 cannot perform authentication in the normal mode.

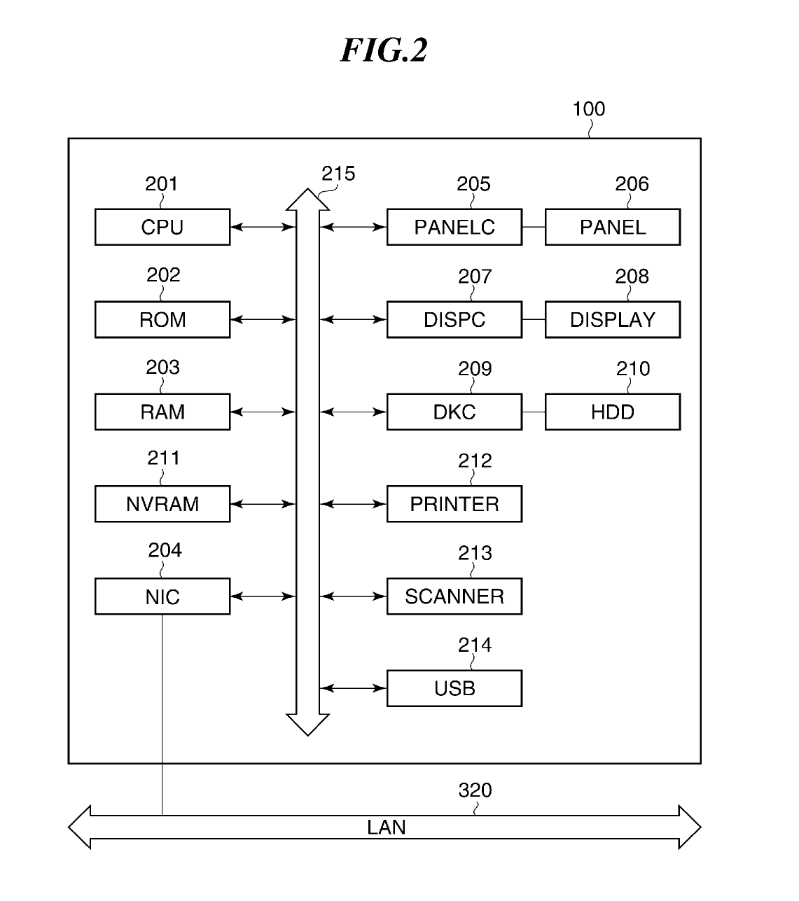

In the present embodiment, upon detecting the card reader 103 being unusable, the MFP 100 switches from an authentication method in the normal mode using a card reader (a first authentication method) to an authentication method using a scanner unit 213 (see FIG. 2) of the MFP 100 (a second authentication method).

The second authentication method is a method in which a surface of the ID card 106 is read using the scanner unit 213 of the MFP 100, user information is obtained from the read image, and the authentication server 102 performs authentication using data of the user information.

FIG. 2 is a block diagram schematically showing an arrangement of a controller unit of the image forming apparatus (MFP) 100. In the MFP 100, a CPU 201, a ROM 202, a RAM 203, a network interface card (NIC) 204, an external input controller (PANELC) 205, and a display controller (DISPC) 207 are connected to a system bus 215. Also, a disk controller (DKC) 209, a nonvolatile memory (NVRAM) 211, a printer unit (PRINTER) 212, and the scanner unit (SCANNER) 213 are connected to the system bus 215.

The system bus 215 is controlled by a bus controller (not shown). In general, a plurality of devices are managed according to an address map, and can be referred to by the CPU 201. The bus controller has a bus bridge function.

The CPU 201 executes software stored in the ROM 202 or a large storage device 210 such as a hard disk. The CPU 201 integrally controls the devices connected to the system bus 215, and executes a boot program and control programs.

The ROM 202 is a boot ROM which stores a boot program. As the ROM 202, any type may be used, but in general, a bus-accessible flush ROM as a nonvolatile memory or the like is used in many cases.

The RAM 203 is memory that is accessible as a volatile memory at high speed and in which data is temporarily stored. In the present embodiment, the RAM 203 acts as a main memory, a work area, and so on for the CPU 201.

The external input controller (PANELC) 205 controls instructions input from an input device (PANEL) 206 such as various types of hard buttons or an operation touch panel provided on the MFP 100. The display controller (DISPC) 207 controls display on a display device (DISPLAY) 208 such as a liquid crystal display or a projector. A plurality of such display devices may be held.

The disk controller (DKC) 209 has an interface (I/F) for inputting and outputting data to and from the hard disk device 210 which is a storage device. The hard disk device 210 stores control programs. The control programs are large in capacity, and hence in a case of a relatively large system, the control programs are stored in the storage device 210 in many cases.

On the other hand, a boot program is stored in many cases in the boot ROM 202, which is a silicon-based nonvolatile memory device resistant to failing, because when the storage device 210 fails, the system must be restored by inserting a new storage device.

The network interface card (NIC) 204 bidirectionally exchanges data with another network device, a file server, or the like, via a network (LAN) 320.

The printer unit 212 and the scanner unit 213 are connected to the bus controller by serial communication, and carry out communication. The card reader 103 (an input unit or a card input device) described above is connected to a USB host controller (USB host) 214. The nonvolatile memory 211 mainly stores initial values and counter values for use at startup.

Next, a description will be given of how the image forming system arranged as described above performs authentication. Here, control and determination processes, described later, are carried out by the CPU 201 executing a control program stored in advance in the ROM 202 or the storage (large storage) device 210.

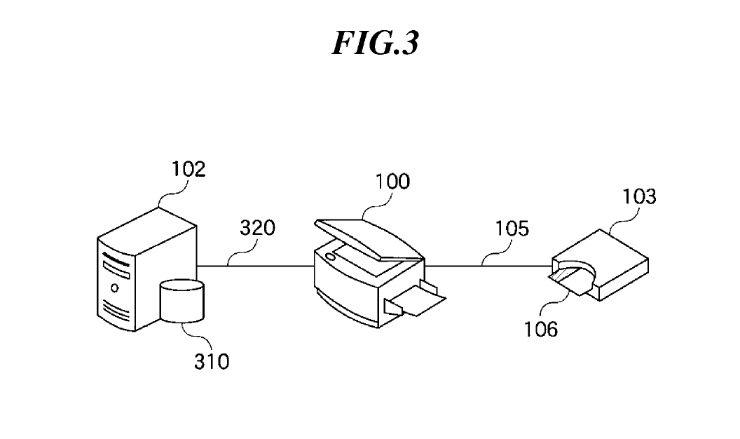

FIG. 3 is a diagram useful in explaining the first authentication method. The authentication server 102, which performs user authentication, is provided with a database (user information DB) 310 in which user information is stored. As described above, the MFP 100 is connected to the authentication server 102 via the network 320. The card reader 103 is connected to the MFP 100 via the USB host 214.

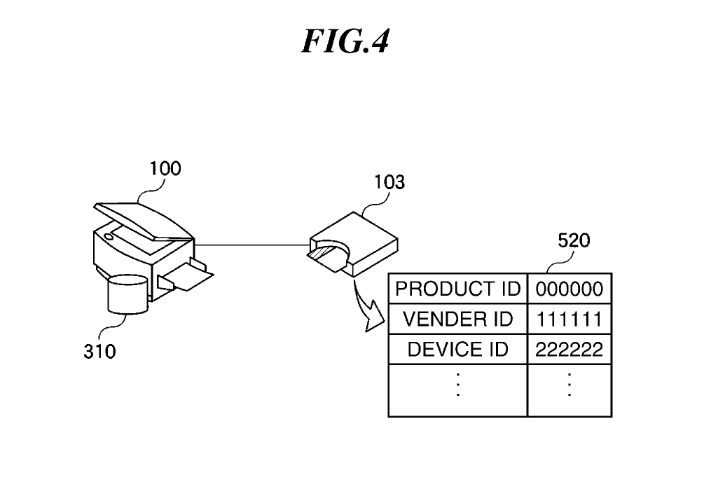

FIG. 4 is a diagram showing data required to detect a failure of the card reader 103. In the present embodiment, information 520 comprised of a product ID, a vender ID, and a device ID is used as data required to detect a failure.

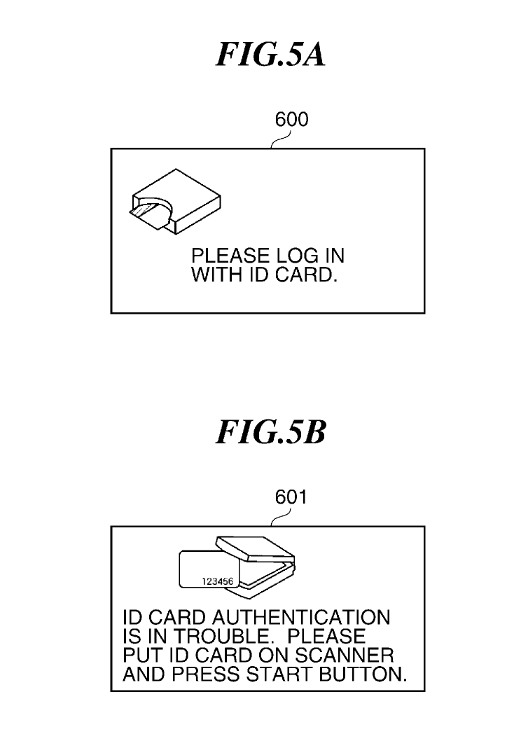

FIGS. 5A and 5B are diagrams showing notification screens for the user, which are displayed on the display device 208 of the MFP 100. As notification screens for the user, a screen 600 prompting login and a screen 601 indicating a failure detected are displayed on the display device 208 which is an UI (user interface).

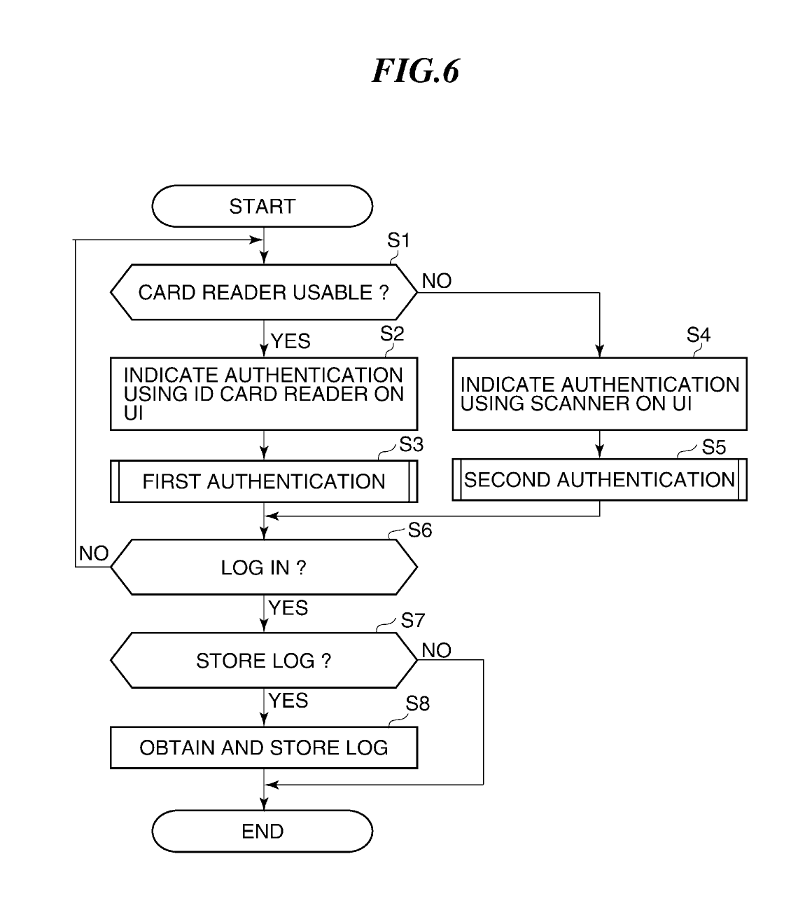

FIG. 6 is a flowchart showing procedures of an authentication switching process. A program for this process is stored in the ROM 202 in the controller unit of the MFP 100, and executed by the CPU 201 after startup of the MFP 100.

First, the CPU 201 determines whether or not the card reader 103 is usable (step S1). As described above, in the present embodiment, the card reader 103 is connected to the MFP 100 via the USB host 214.

In general, information 520 comprised of a product ID, a vender ID, and a device ID is written in a device connected to the USB host 214. By way of the information 520, the CPU 201 stores information on card readers which permits to be used in advance in the user information DB 310 provided in a nonvolatile memory in the MFP 100, such as the NVRAM 211 or the hard disk device (HDD) 210.

Also, when connecting and starting a card reader for the first time, the CPU 201 automatically performs a setup, and adds/stores information on the connected card reader (such as a serial number) to/in the user information DB 310 provided in the nonvolatile memory. Thus, by ensuring consistency between stored data and card reader information at regular intervals, the CPU 201 can detect a failure of the card reader 103.

A connection port of the USB host 214 is provided outside the apparatus in many cases so that the user can freely insert and remove a card reader. It should be noted that, in order to prevent disconnection of a card reader, only a card reader slot may be provided inside the MFP so as to prevent a user from easily removing the card reader. This can prevent unauthorized action by a user. Moreover, in the case where the connection port is provided outside, the CPU 201 may monitor the amount of current to a USB so as to check at regular intervals whether or not a card reader has been removed.

When determining in step S1 that the card reader 103 is usable, the CPU 201 notifies the user that authentication can be performed using the card reader 103 (see the screen 600) via the display device 208 which is a UI (step S2).

Then, the CPU 201 starts executing the first authentication method (step S3). A detailed description will be given later of how the first authentication method is executed.

As a result of authentication using the first authentication method, the CPU 201 determines whether or not it can login (step S6). The CPU 201 receives, from the authentication server 102, information indicative of whether or not it can login. When the CPU 201 can login, that is, when authentication is successful, the CPU 201 logs in, and switches the display device 208, which is an UI, to a normal operation screen. The process in the step S6 is an example of a usage permission unit.

On the other hand, when the CPU 201 cannot login, it returns to the process in the step S1 to determine again whether or not the card reader 103 is usable. Whether or not the card reader 103 is usable is determined in the above described manner.

When determining in step S1 that the card reader 103 is not usable, the CPU 201 notifies the user that authentication will be performed using the scanner unit 213 of the MFP 100 instead of a card reader (see the screen 601) via the display device 208 which is a UI (step S4). The process in the step S4 is an example of a notification unit.

The CPU 201 starts executing the second authentication method (step S5). A detailed description will be given later of how the second authentication method is executed. It should be noted that the process in the step S1 in which it is determined that the card reader 103 is not usable (“NO”) and the processes in the steps S4 and S5 correspond to a switching unit.

As a result of the process using the second authentication method, the CPU 201 determines in the step S6 whether or not it can login. Whether or not the CPU 201 can login is determined in the above described manner. When the CPU 201 can login, that is, when authentication is successful, the CPU 201 logs in and switches the display device 208, a UI, to a normal operation screen.

After that, the CPU 201 determines whether or not log obtainment is configured (step S7). In the later description of the second authentication process, a detailed description will be given of how log obtainment is configured. When log obtainment is not configured, the CPU 201 terminates the present process.

On the other hand, when log obtainment is configured, the CPU 201 stores authenticated user information and data such as images manipulated by the user in a storage area of the MFP 100 or a storage area accessible from the MFP 100 (such as a server on the network) (step S8). In the later description of the second authentication process, a detailed description will be given of exemplary stored data, etc. After that, the CPU 201 terminates the present process.

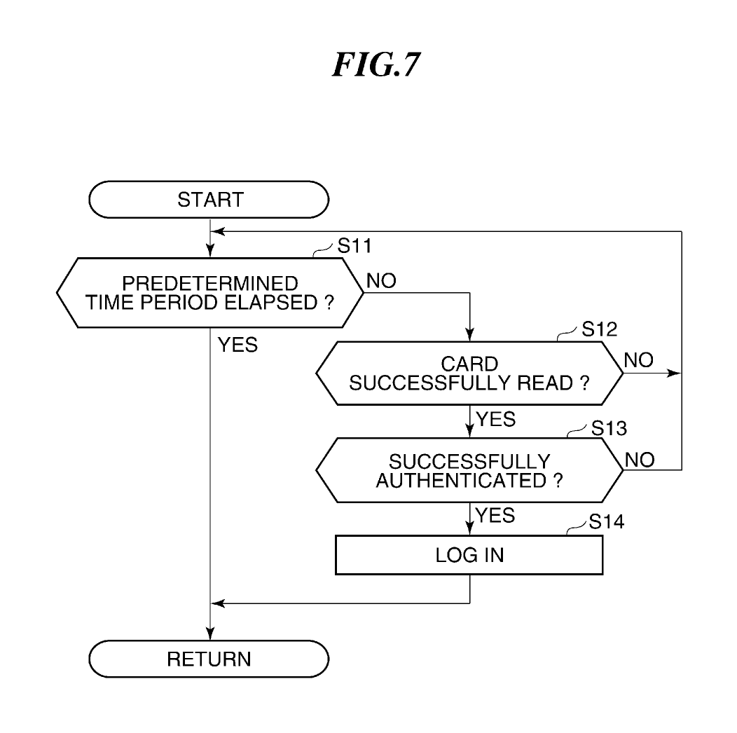

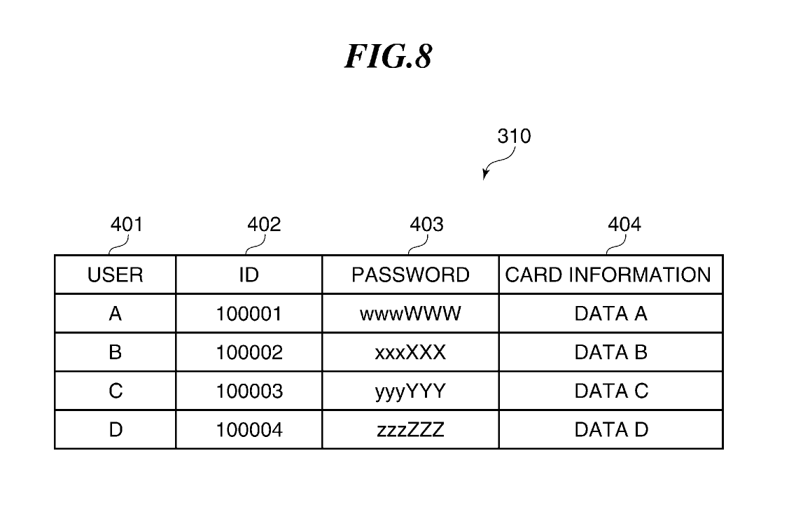

Next, a description will be given of the first authentication method. FIG. 7 is a flowchart showing procedures of a first authentication process in the step S3. FIG. 8 is a diagram showing exemplary data stored in the user information DB 310.

First, the CPU 201 starts the first authentication process and then determines whether or not a predetermined time period has elapsed (step S11). Here, the predetermined time period is a time period for polling to determine in the step S1 whether or not a card reader is usable. The predetermined time period is set in advance and stored in, for example, the ROM 202 in the controller unit of the MFP 100.

When determining that the predetermined time period has elapsed, the CPU 201 holds information that it has not logged in, terminates the present process, returns to the previous process, and proceeds to the next step S6.

On the other hand, when determining in the step S11 that the predetermined time period has not elapsed, the CPU 201 reads information on the user's ID card 106 via the card reader 103, and determines whether or not the information can be obtained (step S12).

When the information cannot be obtained, the CPU 201 returns to the process in the step S11.

On the other hand, when the information can be obtained from the ID card 106, the CPU 201 sends the information obtained in the step S12 to the authentication server 102, and upon receiving the authentication result, determines whether or not authentication is successful (step S13).

It should be noted that although the MFP 100 and the authentication server 102 are connected together via the network, they can be connected together using any connection method as long as they can access each other. For example, the authentication server may be held in the MFP, or the MFP and the authentication server may be connected together via a dedicated line or the like.

In the user information DB 310 (a specific storage unit), a user 401, an ID 402, a password 403, and card information 404 are registered as shown in FIG. 8. In the first authentication process, authentication is performed using the card information 404 (registration information). The obtainment of the card information 404 corresponds to a registration information obtaining unit.

When determining in the step S13 authentication is successful, the CPU 201 holds information that it can log in (step S14), returns to the previous process, and proceeds to the step S6.

On the other hand, when determining in the step S13 that authentication is unsuccessful, the CPU 201 returns to the process in the step S11.

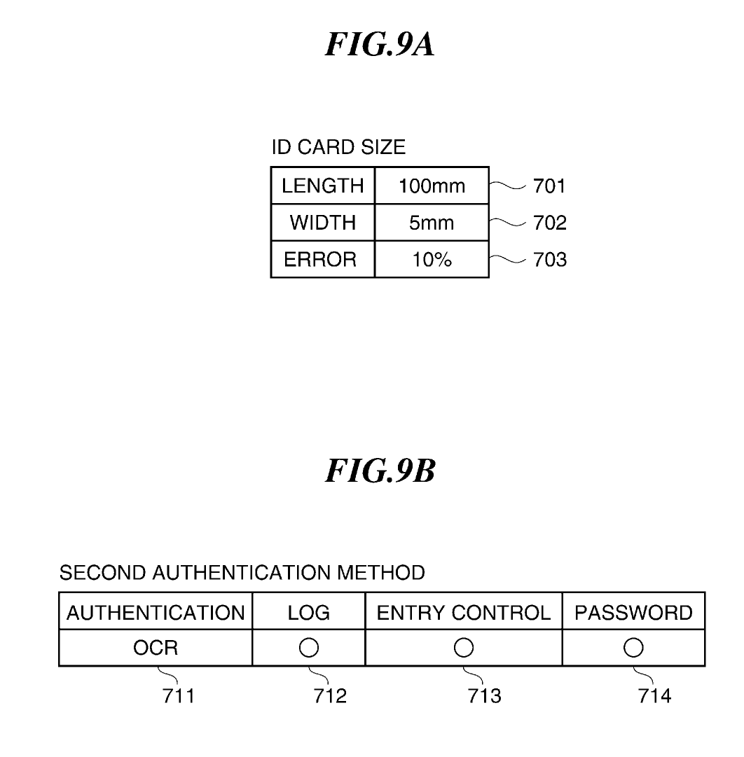

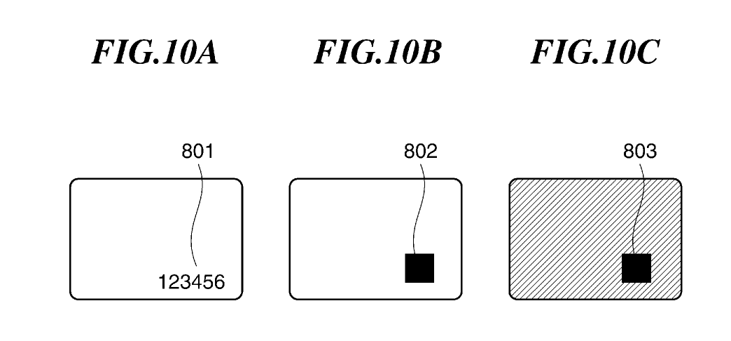

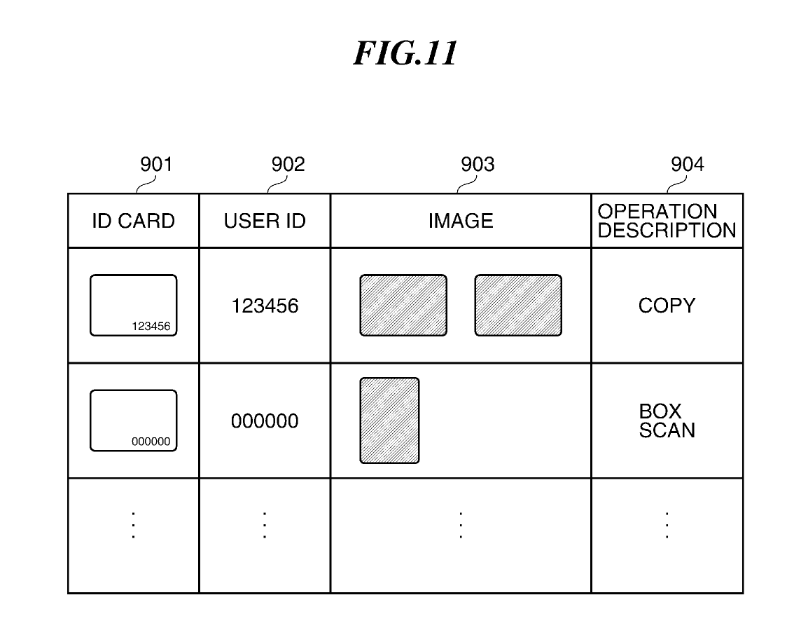

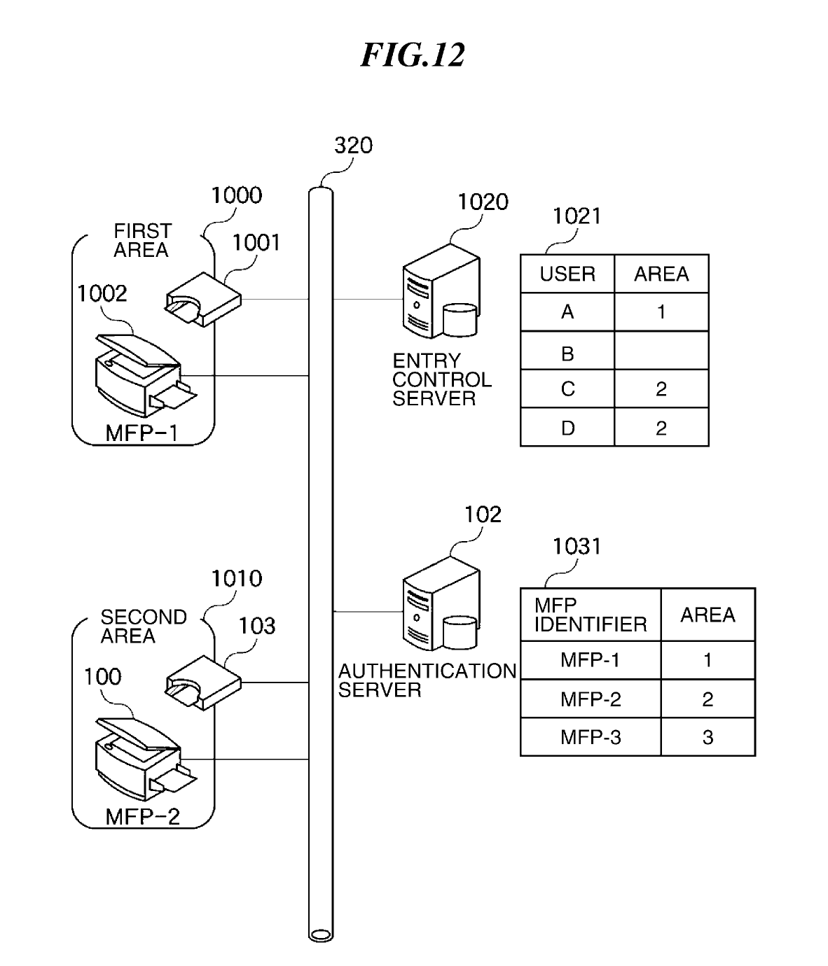

Next, a description will be given of the second authentication method. FIGS. 9A and 9B are views showing tables providing a listing of information on an ID card and settings on the second authentication method, which are stored in the ROM 202 in the controller unit of the MFP 100. FIGS. 10A to 10C are diagrams showing types of ID cards to be used. FIG. 11 is a diagram showing an exemplary stored log in a case where log obtainment is configured using the second authentication method. FIG. 12 is a diagram showing an entry control system and a user authentication system.

In the second authentication method, there are items that must be registered in advance by an administrator. First, information on ID cards to be used is registered. The administrator registers in advance, in a storage area of the MFP or a storage area accessible from the MFP (such as a server on the network), a length 701 and a width 702, a size of ID cards to be used, and an error range 703 for use in determining the validity of an ID card. It should be noted that although the three items are named here, any items may be used as long as they can be used to determine the validity of an ID card.

Next, as is the case with the determination regarding the validity of an ID card, the administrator registers, in a storage area of the MFP or a storage area accessible from the MFP, items to be used in the second authentication method. In the present embodiment, as the items to be used in the second authentication method, an item 711 of “authentication method”, an item 712 of “store log”, an item 713 of “work with entry control system”, and an item 714 of “request password entry” can be registered.

In the item of “authentication method”, information indicative of how user information is obtained from an ID card is registered. Specifically, there are the following two types of authentication methods: a method in which a user is identified by reading a number portion 801 of an ID card using an OCR (optical character reader) and a method in which a user is identified by reading a two-dimensional barcode 802 printed on an ID card. In either method, user information is obtained from an image of an ID card, and it is thus necessary to prevent an ID card from being easily copied. Thus, to enhance security, a textured card 803 may be used.

Also, “store log” means storing obtained information on a user and data (images) manipulated by the user in a storage area of the MFP or a storage area accessible from the MFP (such as a server on the network) only in the case where authentication is performed using the second authentication method. By storing a log in this way, the administrator can ascertain later whether or not there has been unauthorized use.

Also, “work with entry control system” means determining whether or not a user identified by obtained user information is present in the same area as the area where the MFP being operated is installed. When the identified user is not present in the same area as the area where the MFP being operated is installed, there is a high possibility that there has been unauthorized use of an ID card, and hence the usage of the ID card can be restricted. Also, “password” means usage of a password for user authentication.

When the administrator selects “work with entry control system”, the entry control system must also use ID cards used in the first and second authentication methods.

In a first area 1000, a card reader 1001 for controlling entry is installed. Similarly, in a second area 1010, the above described card reader 103 is installed. By performing scanning and authentication using these card readers, users can enter and leave each area.

The locations of respective users are managed by an entry control server 1020. For example, when a user A uses the card reader 1001 and enters the first area 1000, the entry control server 1020 is notified that the user A has entered the first area 1000, and data 1021 is updated.

Further, the administrator must register, in the authentication server 102, areas where respective MFPs are installed. When a first MFP (MFP-1) 1002 is installed in the first area 1000, and the second MFP (MFP-2) 100 is installed in the second area 1010, MFP identifiers (MFP-1, MFP-2, . . . ) of the respective MFPs are registered in a table 1031.

The card readers 1001 and 103 for entering/leaving a room, the MFPs 1002 and 100, the entry control server 1020, and the authentication server 102 are connected together via the network 320.

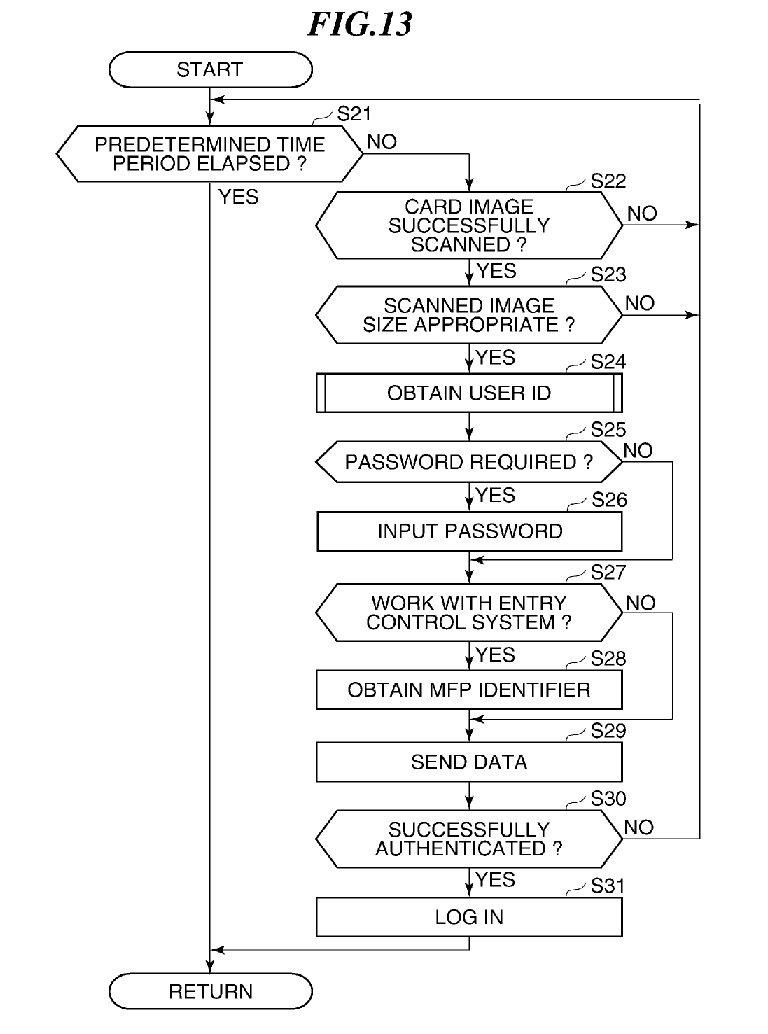

FIG. 13 is a flowchart showing procedures of the second authentication process in the step S5. First, as in the step S11, the CPU 201 determines whether or not a predetermined time period has elapsed since the start of the second authentication process (step S21).

When determining that the predetermined time period has elapsed, the CPU 201 holds information that it has not logged in, returns to the previous process, and proceeds to the step S6.

On the other hand, when determining in the step S21 that the predetermined time period has not elapsed, the CPU 201 reads a surface image of the ID card using the scanner unit 213 of the MFP 100, and determines whether or not the image can obtained (step S22).

When the image of the ID card cannot be obtained, the CPU 201 returns to the process in the step S21. On the other hand, when the image of the ID card can be obtained, the CPU 201 determines whether or not the image of the ID card is valid (step S23). The process in the step S23 is an example of a validity determination unit.

Here, whether or not the image of the ID card is valid is determined using the above described image size (see FIG. 9A). As described above, the administrator registers in advance, in a storage area of the MFP or a storage area accessible from the MFP 100 (such as a server on the network), the length 701, the width 702, and the valid error range 703 as an image size of ID card.

The CPU 201 measures the size of the image obtained in the step S22, compares the measured size with the ID card image size registered in advance (see FIG. 9A), and determines whether or not the measured size is within the error range (step S23). When the measured size is within the error range, the CPU 201 determines that the image of the ID card is valid.

When determining that the image of the ID card is not valid, the CPU 201 returns to the process in the step S21. On the other hand, when determining in the step S23 that the image of the ID card is valid, the CPU 201 obtains the user ID 402 (see FIG. 8) from the image of the ID card obtained in the step S22 (step S24). The process in the step S24 is an example of an identification information obtaining unit. A detailed description of this user ID obtaining process will be given later.

The CPU 201 determines whether or not a password is required for authentication (step S25). As described above, regarding whether or not a password is required for authentication, the administrator registers in advance the item 714 of “request password entry” as an item to be used in the second authentication method. When this item is “o”, a password is required, and on the other hand, when this item is “x”, a password is not required.

When determining in the step S25 that a password is not required, the CPU 201 proceeds to step S27. On the other hand, when determining in the step S25 that a password is required, the CPU 201 notifies the user that entry of a password is required via the display device (UI) 208, so that the user inputs a password via the input device 206 (step S26). As the input device 206, hard buttons or an operation touch panel is used. The process in the step S26 is an example of a password input unit as another information obtaining unit.

After that, the CPU 201 determines whether or not to use the entry control system for authentication (step S27). As described above, regarding whether or not to use the entry control system, the administrator registers in advance the item 713 of “work with entry control system” as an item to be used in the second authentication method. When this item is “o”, the entry control system is used, and on the other hand, when this item is “x”, the entry control system is not used.

When determining not to use the entry control system, the CPU 201 proceeds to step S29. On the other hand, when determining to use the entry control system, the CPU 201 obtains MFP identification information (step S28). Here, the MFP identification information means an MFP identifier registered in advance in the authentication server 102 by the administrator as described above (see the table 1031 in FIG. 12).

The CPU 201 sends the authentication server 102 the user ID obtained in the step S24, the password if obtained in the step S26, and the MFP identifier if obtained in the step S28 (step S29).

The authentication server 102 performs user authentication using the data received as a result of the sending in the step S29, and the user information DB (see FIG. 8).

First, the authentication server 102 identifies the user 401 based on the user ID obtained in the step S24. Then, if there is a password obtained in the step S26, the authentication server 102 compares the password with the password 403 in the user information DB. When, as a result of the comparison, the passwords are different, authentication is unsuccessful. Then, if there is an MFP identifier obtained in the step S28, the authentication server 102 sends information on the user ID 401 identified earlier to the entry control server 1020, and inquires of the entry control server 1020 about an area where the user is present. Then, the authentication server 102 determines whether or not the area where the user is present is the same as the area where the MFP is installed, which was obtained in the step S28. When, as a result of the determination, the areas are different, the usage of the card is considered unauthorized, and authentication is unsuccessful.

Upon receiving the authentication result from the authentication server 102, the CPU 201 determines whether or not authentication is successful (step S30). When determining that authentication is unsuccessful, the CPU 201 returns to the process in the step S21.

On the other hand, when determining in the step S30 that authentication is successful, the CPU 201 holds information that it can log in (step S31), returns to the previous process, and proceeds to the step S6.

After logging in, the CPU 201 obtains the item 712 of “store log”, and determines whether or not log obtainment is configured. When log obtainment is configured, the CPU 201 stores an authentication log in a storage area (see FIG. 11). The authentication log includes the ID card image 901 obtained in the step S22, the user ID 902 obtained in the step S24, the image or data 903 manipulated after login, and an operation description 904. As the storage area for the authentication log, a storage area of the MFP or a storage area accessible from the MFP (such as a server on the network) is used.

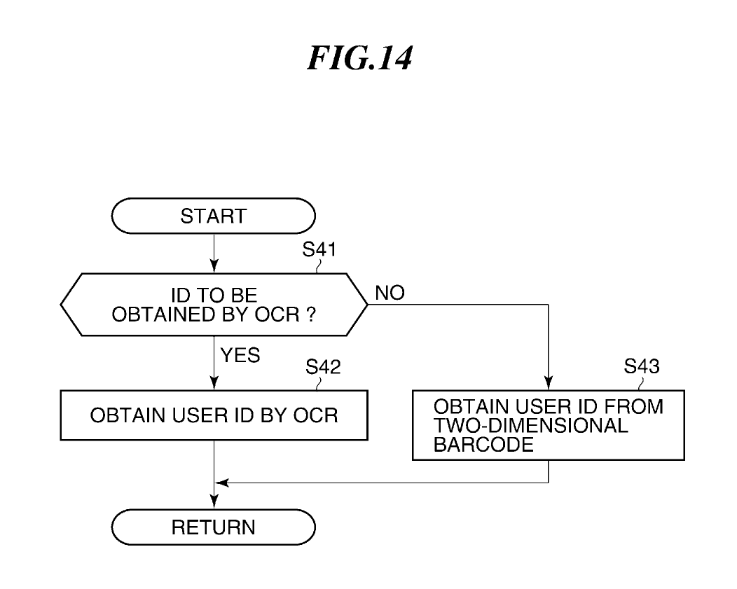

FIG. 14 is a flowchart showing procedures of the user ID obtaining process in the step S24. First, the CPU 201 obtains a user ID obtaining method from the item 711 of “authentication method” (step S41).

The CPU 201 determines whether or not the user ID obtaining method is using OCR (step S41). When the user ID obtaining method is using OCR, the CPU 201 obtains characters through OCR from the image obtained in the step S23, and obtains an ID number recognized from the obtained characters (step S42). The process in the step S42 is an example of a character obtaining unit. After that, the CPU 201 returns to the previous process.

On the other hand, when the user ID obtaining method is obtainment using a two-dimensional barcode, the CPU 201 obtains an ID number by extracting a two-dimensional barcode portion from the image obtained in the step S23 and analyzing (decoding) the extracted barcode (step S43). The process in the step S43 is an example of an analysis unit. After that, the CPU 201 returns to the previous process.

As described above, according to the image forming system of the present embodiment, when services are to be provided for the user by performing authentication, authentication can be performed even in a case where a card reader for use in authentication fails. Namely, by switching to the second authentication method using the scanner unit of the MFP and performing authentication, services can be provided for the user. Moreover, by switching authentication methods, the user can continuously use services.

Moreover, because in a case where the authentication method is switched from the first authentication method to the second authentication method, notification of the switching to the second authentication method is provided via the display device, a UI, the user can instantaneously understand which authentication method to use in authentication.

Moreover, because authentication is performed using registration information registered in the user information DB, authentication can be made easier.

Also, because an image of an ID card is read, other objects to be read are not required, and hence the ease of operation can be enhanced.

Moreover, by using a user ID and a password or by working with the entry control system, unauthorized use can be prevented, and security can be improved.

Moreover, because in authentication performed by the second authentication unit as well, identification information is used, the same authentication can be performed as in authentication performed by the first authentication. Moreover, because images of various ID cards can be read, the number of types of images to be read can be increased. Also, because logs are stored, the administrator can ascertain later whether or not there has been an unauthorized use.

It should be noted that the present invention is not limited to the arrangement of the above described embodiment, but the present invention may be applied to any arrangements as long as they can realize the functions defined in the scope of claims or the functions which the arrangement of the present embodiment has.

For example, although in the above described embodiment, a card reader is used as the input unit, a keyboard or the like which a user can operate may be used.

Further, the present invention may be applied to either a system comprised of a plurality of devices or an apparatus comprised of one device. Moreover, the image processing apparatus has only to have an image reading function, and of course, may be an MFP alone, a facsimile apparatus having a printing function, a scanner apparatus, an information terminal apparatus, or the like as well as the above described image forming system including the MFP.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-224770 filed Sep. 29, 2009, which is hereby incorporated by reference herein in its entirety.

What is claimed is:

1. An image processing apparatus that has a scanner that reads images, and performs printing processing on images read by the scanner, comprising:
an input unit configured to input identification information;
a first authentication unit configured to perform authentication using the identification information input by said input unit;
a failure detection unit configured to detect a failure of said input unit;
a second authentication unit configured to perform authentication using information on an image read by the scanner;
a usage permission unit configured to permit usage of the image processing apparatus when authentication performed by said first authentication unit or said second authentication unit is successful; and
a switching unit configured to switch from authentication performed by said first authentication unit to authentication performed by said second authentication unit when said failure detection unit detects a failure of said input unit.

2. An image processing apparatus according to claim 1, further comprising a notification unit configured to provide notification that said switching unit has switched to authentication performed by said second authentication unit.

3. An image processing apparatus according to claim 1, further comprising a registration information obtaining unit configured to obtain registration information registered in a specific storage unit,
wherein said first and second authentication units perform authentication using the registration information obtained by said registration information obtaining unit.

4. An image processing apparatus according to claim 1, wherein said input unit comprises a card input device into which a card in which the identification information is recorded is inserted, and inputs the identification information recorded in the card, and
said second authentication unit performs authentication using information on an image of the card read by the scanner.

5. An image processing apparatus according to claim 1, wherein said second authentication unit comprises a validity determination unit that determines whether information of an image read by the scanner is valid, and performs authentication using the information of the image when it is determined that the information of the image is valid.

6. An image processing apparatus according to claim 1, wherein said second authentication unit comprises an identification information obtaining unit that obtains identification information from an image read by the scanner, and performs authentication using the identification information obtained by the identification information obtaining unit.

7. An image processing apparatus according to claim 6, wherein said identification information obtaining unit comprises a character obtaining unit that obtains characters from the image, and obtains identification information recognized from the characters obtained by the character obtaining unit.

8. An image processing apparatus according to claim 6, wherein said identification information obtaining unit comprises an analysis unit that reads a two-dimensional barcode from the image and analyzes the barcode, and obtains identification information analyzed by the analysis unit.

9. An image processing apparatus according to claim 1, wherein said second authentication unit comprises another information obtaining unit that obtains information other than the identification information.

10. An image processing apparatus according to claim 9, wherein said second authentication unit comprises, as the other information obtaining unit, a password input unit that inputs a password, and performs authentication using the password input by said password input unit.

11. An image processing apparatus according to claim 9, wherein said second authentication unit comprises, as the other information obtaining unit, an entry control unit that controls entering/leaving by a user, and performs authentication using the identification information obtained by the identification information obtaining unit when the entry control unit ascertains that the user is present in an area where the image processing apparatus is installed.

12. An image processing apparatus according to claim 1, wherein said second authentication unit stores an authentication log when having performed authentication.

13. An authentication method for an image processing apparatus that performs printing processing on images read by a scanner, comprising:
a failure detection step of detecting a failure of an input unit that inputs identification information;
a first authentication step of, when a failure of the input unit is not detected in said failure detection step, performing authentication using the identification information input by the input unit;
a second authentication step of, when a failure of the input unit is detected in said failure detection step, performing authentication using information of an image read by the scanner; and
a usage permission step of permitting usage of the image processing apparatus when authentication performed in said first authentication step or said second authentication step is successful.

14. A non-transitory computer-readable storage medium storing a program for causing a computer to execute an authentication method for an image processing apparatus that performs printing processing on images read by a scanner, the authentication method comprising:
a failure detection step of detecting a failure of an input unit that inputs identification information;
a first authentication step of, when a failure of the input unit is not detected in the failure detection step, performing authentication using the identification information input by the input unit;
a second authentication step of, when a failure of the input unit is detected in the failure detection step, performing authentication using information of an image read by the scanner; and
a usage permission step of permitting usage of the image processing apparatus when authentication performed in the first authentication step or the second authentication step is successful.
